(19) United States
(12) Patent Application Publication
(10) Pub. No.: US 2026/0066435 A1
(43) Pub. Date: Mar. 5, 2026

(54) ELECTRICITY STORAGE APPARATUS

(71) Applicant: TOYOTA JIDOSHA KABUSHIKI KAISHA, Toyota-shi (JP)

(72) Inventors: Toshio UCHIYAMA, Toyota-shi (JP); Hiroki Yamauchi, Niwa-gun (JP)

(73) Assignee: TOYOTA JIDOSHA KABUSHIKI KAISHA, Toyota-shi (JP)

(21) Appl. No.: 19/229,121

(22) Filed: Jun. 5, 2025

(30) Foreign Application Priority Data
Aug. 30, 2024 (JP) 2024-148644

(51) Int. Cl. H01M 50/262; H01M 50/204; H01M 50/242

(52) U.S. Cl. CPC H01M 50/262; H01M 50/204; H01M 50/242

(57) ABSTRACT

An electricity storage apparatus according to the present disclosure includes a plurality of battery modules and a rack that accommodates the battery modules. The rack has a plurality of support plates that supports the battery modules. A bottom surface of each of the battery modules and a main surface of each of the support plates are fastened to each other. Each of the support plates is joined, via a bracket fastened on the main surface of the support plate, to another of the support plates. With such configuration, the electricity storage apparatus according to the present disclosure enables the accommodated battery modules to be sufficiently fixed even when a storage battery vibrates due to earthquake, transportation, and the like. As a result, the electricity storage apparatus according to the present disclosure enables the quake resistance to be improved.

### CROSS-REFERENCE TO RELATED APPLICATION

This application claims priority to Japanese Patent Application No. 2024-148644 filed on Aug. 30, 2024. The disclosure of the above-identified application, including the specification, drawings, and claims, is incorporated by reference herein in its entirety.

### BACKGROUND

### 1. Technical Field

The present disclosure relates to an electricity storage apparatus.

### 2. Description of Related Art

In Japanese Unexamined Patent Application Publication No. 2021-132006 (JP 2021-132006 A), an electricity storage apparatus including battery modules, a control unit of the battery modules, a rack that accommodates the battery modules and the control unit, and a cover that covers the rack is described. In the electricity storage apparatus described in JP 2021-132006 A, each battery module is fixed from a side surface with use of a fixing fitting.

### SUMMARY

As described above, in the electricity storage apparatus described in JP 2021-132006 A, the battery module is fixed with only the fitting mounted on the side surface.

Therefore, in the electricity storage apparatus described in JP 2021-132006 A, there has been a fear that the battery module may not be sufficiently fixed when vibration occurs due to earthquake, transportation, and the like. In other words, in the electricity storage apparatus according to the related-art, there has been a problem in that quake resistance has been insufficient.

The present disclosure has been made in order to solve the problem as above and an object thereof is to provide an electricity storage apparatus capable of improving quake resistance.

An electricity storage apparatus according to the present disclosure includes a plurality of battery modules, and a rack that accommodates the battery modules. The rack has a plurality of support plates that supports the battery modules. A bottom surface of each of the battery modules and a main surface of each of the support plates are fastened to each other. Each of the support plates is joined, via a bracket fastened on the main surface of the support plate, to another of the support plates. With such configuration, the electricity storage apparatus according to the present disclosure enables the accommodated battery modules to be sufficiently fixed even when a storage battery vibrates due to earthquake, transportation, and the like. As a result, the electricity storage apparatus according to the present disclosure enables the quake resistance to be improved.

In the electricity storage apparatus according to the present disclosure, the bracket may have a U-shaped section. With such configuration, the electricity storage apparatus according to the present disclosure enables the support plates to be joined in a firmer manner. As a result, the electricity storage apparatus according to the present disclosure enables the quake resistance to be improved more.

The electricity storage apparatus according to the present disclosure may further include a casing that accommodates the battery modules and the rack. The bracket may be fastened to a side wall of the casing. With such configuration, the electricity storage apparatus according to the present disclosure enables the battery modules, the support plates, and the brackets to be fixed in a firmer manner. As a result, the electricity storage apparatus according to the present disclosure enables the quake resistance to be improved more.

The electricity storage apparatus according to the present disclosure may further include a casing that accommodates the battery modules and the rack. A sealing surface of the casing may be disposed so as not to intersect with the rack.

With such configuration, the electricity storage apparatus according to the present disclosure enables the battery modules and the rack to be accommodated on the inside of the casing having a high strength. As a result, the electricity storage apparatus according to the present disclosure enables the quake resistance to be further improved.

By the present disclosure, it becomes possible to provide the electricity storage apparatus excellent in quake resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing the configuration of an electricity storage apparatus according to a first embodiment;

FIG. 2 is a perspective view showing an internal apparatus of the electricity storage apparatus according to the first embodiment;

FIG. 3 is a perspective view showing the configuration of a battery module and a support plate according to the first embodiment; and

FIG. 4 is a perspective view showing the configuration of a bracket according to the first embodiment.

### DETAILED DESCRIPTION OF EMBODIMENTS

### First Embodiment

### Configuration of Electricity Storage Apparatus

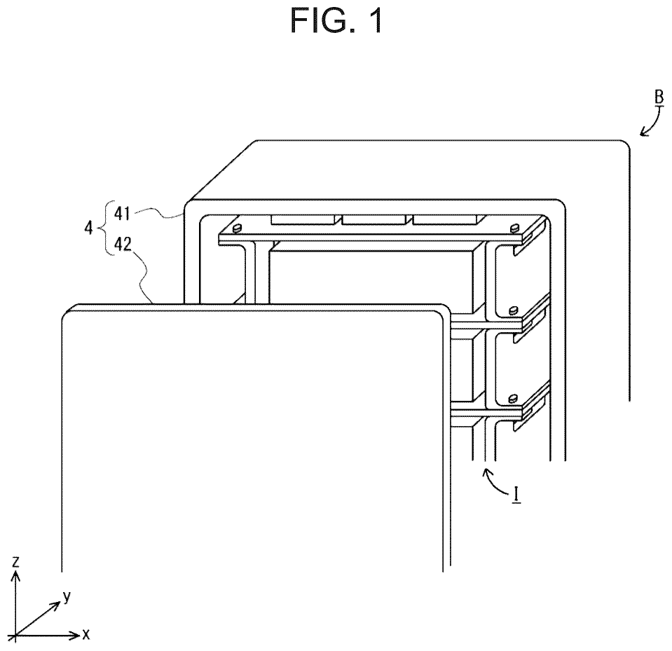

With reference to the drawings, a first embodiment according to the present disclosure is described below in detail. FIG. 1 is a perspective view for describing the configuration of an electricity storage apparatus according to the first embodiment.

As a matter of course, right-handed xyz orthogonal coordinates shown in FIG. 1 and other drawings are expedient coordinates for describing the positional relationship between components. In the present embodiment, the z-axis positive direction and the xy-plane in FIG. 1 and the other drawings are the vertically upper direction and the horizontal plane, respectively, and the z-axis positive direction and the xy-plane are shared between the drawings.

A electricity storage apparatus B is a fixed-type electricity storage apparatus. For example, the electricity storage apparatus B is installed in a house and the like and is used for the purpose of storing therein household electricity, reserve electricity in case of emergency, electricity to be sold, and the like. The electricity storage apparatus B includes an internal apparatus I, a casing 4, and an exterior cover (not shown). The exterior cover is a cover provided so as to surround the periphery of the casing 4 and has a role of protecting the casing 4 and the internal apparatus I from flying objects, a role of improving design properties, and the like.

As shown in FIG. 1, in the electricity storage apparatus B according to the present embodiment, the internal apparatus I is accommodated in an inner space of the casing 4.

The casing 4 is a box-shaped structure body that protects the internal apparatus I and is typically configured with a main material of metal. The casing 4 includes a casing main body 41 and a casing lid portion 42.

The casing main body 41 is a substantially cuboid box-shaped structure body having an opening portion parallel to the zx-plane. The opening portion of the casing main body 41 is sealed by the casing lid portion 42 that is a plate-shaped structure body. The casing main body 41 accommodates the internal apparatus I on its inside.

The casing main body 41 is fastened to the internal apparatus I on its inner wall surface.

Although details are described later, the casing main body 41 according to the present embodiment is fastened to the internal apparatus I on an inner wall surface parallel to the zx-plane, in other words, a side wall thereof.

The casing main body 41 according to the present embodiment is fastened to the internal apparatus I on a surface positioned on the z-axis negative side out of planes parallel to the xy-plane, in other words, a bottom surface thereof.

The casing 4 is fixed to an installment surface on which the electricity storage apparatus B is disposed. Therefore, the internal apparatus I is also fixed to the installment surface via the casing 4.

With the configuration as above, the electricity storage apparatus B according to the present embodiment enables the casing 4 and the internal apparatus I to be suitably fixed. As a result, it is possible to improve the quake resistance.

Here, as shown in FIG. 1, the casing main body 41 according to the present embodiment is configured such that the opening portion parallel to the zx-plane is positioned on the y-axis direction negative side relative to the internal apparatus I.

In other words, regarding the casing 4 according to the present embodiment, a sealing surface is disposed so as not to intersect with a rack 3 included in the internal apparatus I.

With such configuration, in the casing 4, joint lines with respect to the casing lid portion 42 do not necessarily need to be provided on an upper surface and a bottom surface parallel to the xy-plane and side surfaces parallel to the yz-plane. As a result, it is possible to improve the strength of the casing 4.

With such configuration, it is possible to configure the casing lid portion 42 as a simple plate-shaped structure body, and hence it is possible to reduce the manufacturing cost.

As shown in FIG. 1, the casing main body 41 according to the present embodiment has an opening portion in a manner that is parallel to a main surface of the internal apparatus I having a substantially cuboid shape.

With such configuration, at the time of manufacturing, the internal apparatus I is easily accommodated in the casing 4. As a result, it is possible to improve the manufacturing efficiency.

The casing 4 is sealed as a result of mechanically fastening the casing main body 41 and the casing lid portion 42 to each other along outer edges of the opening portion of the casing main body 41. A method of mechanically fastening the casing main body 41 and the casing lid portion 42 to each other is not particularly limited, but it is preferable to perform fastening with use of a demountable method in order to regularly perform maintenance of the internal apparatus I.

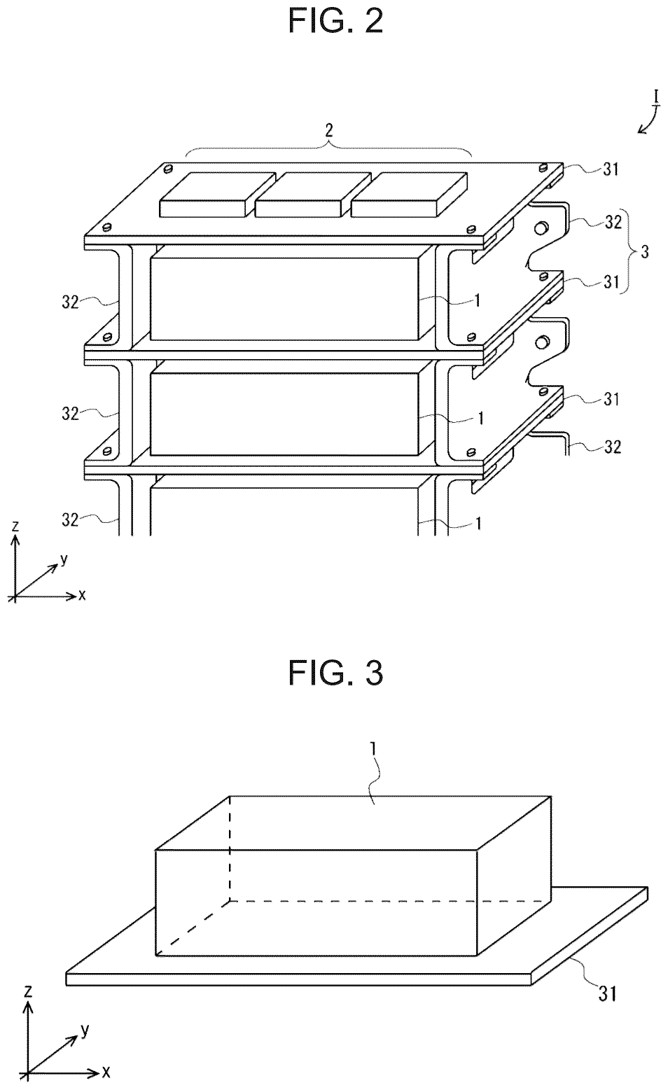

FIG. 2 is a perspective view showing the internal apparatus of the electricity storage apparatus according to the first embodiment.

The internal apparatus I is an apparatus accommodated on the inside of the casing 4 and has functions of operation control of the electricity storage apparatus B, input and output of electricity, storage of electricity, and the like.

The internal apparatus I includes the battery modules 1, the control unit 2, and the rack 3.

The battery module 1 is a secondary battery such as a lithium-ion battery or a nickel hydride battery. The battery module 1 operates based on the control of the control unit 2.

Specifically, the battery module 1 receives supply of electricity from the outside and stores the supplied electricity therein based on the control of the control unit 2. Then, the battery module 1 supplies the stored electricity to the outside based on the control of the control unit 2. In other words, the battery module 1 exchanges electricity with the outside based on the control of the control unit 2.

The battery module 1 exchanges electricity with the outside via a cable (not shown in FIG. 2).

As shown in FIG. 2, the electricity storage apparatus B according to the present embodiment includes a plurality of the battery modules 1, and the battery modules 1 are arranged in the z-axis direction, in other words, the vertical direction and are accommodated in the rack 3.

Here, regarding the battery module 1, a surface positioned on the z-axis negative side out of surfaces parallel to the xy-plane, in other words, a bottom surface is supported by a support plate 31. Although details are described later, the bottom surface of the battery module 1 and a main surface of the support plate 31 are fastened to each other.

Regarding the battery module 1, a surface positioned on the z-axis positive side out of the surfaces parallel to the xy-plane, in other words, an upper surface is covered by the support plate 31 different from the support plate 31 described above. Regarding the battery module 1, two side surfaces parallel to the yz-plane are covered by brackets 32 described later.

In other words, the battery module 1 is accommodated in a space configured by two support plates 31 and two brackets 32.

The control unit 2 controls the operation of the electricity storage apparatus B.

For example, the control unit 2 may control the electricity amount supplied to the battery module 1 from the outside or the electricity amount supplied to the outside from the battery module 1.

For example, the control unit 2 may execute the monitoring of the temperature of a battery, the voltage, and the like, the calculation of a limit value relating to the voltage and the current to the battery, and the communication with an external apparatus.

For example, the control unit 2 includes a computing unit such as a central processing unit (CPU), and a storage unit such as a random access memory (RAM) or a read only memory (ROM) that stores therein a program and data for controlling the electricity storage apparatus B (not shown). In other words, the control unit 2 has a function as a computer and controls the operation of the electricity storage apparatus B based on the program.

Therefore, each function executed by the control unit 2 that is exemplified can be configured by the CPU, the storage unit, other circuits, and the like in terms of hardware and can be implemented by the program for controlling the electricity storage apparatus B stored in the storage unit and the like in terms of software. In other words, the control unit 2 can be realized by various forms by hardware, software, or a combination thereof.

The program includes an instruction group (or a software code) for causing a computer to perform one or more functions described in the embodiment when the instruction group (or the software code) is read into the computer. The program may be stored in a non-transitory computer-readable medium or a tangible storage medium. As an example and not as a limitation, the computer-readable medium or the tangible storage medium includes a random-access memory (RAM), a read-only memory (ROM), a flash memory, a solid-state drive (SSD), or other memory technologies, a CD-ROM, a digital versatile disc (DVD), a Blu-ray (R) disc, or other optical disc storages, and a magnetic cassette, a magnetic tape, a magnetic disk storage, or other magnetic storage devices. The program may be transmitted on a transitory computer-readable medium or a communication medium. As an example and not as a limitation, the transitory computer-readable medium or the communication medium includes electrical, optical, or acoustic propagation signals or propagation signals in other formats.

The rack 3 is a shelf-shaped structure body that accommodates the battery modules 1 and the control unit 2. The rack 3 has, in a vertical arrangement, cuboid accommodation spaces in which the battery modules 1 can be accommodated, and one or more battery modules 1 are accommodated in each accommodation space. Regarding the rack 3, the control unit 2 is installed on an upper surface.

The rack 3 is fixed to the installment surface of the electricity storage apparatus B via the casing 4. In more detail, the rack 3 is fastened to the side wall and the bottom surface of the casing 4 fixed to the installment surface. As a result, the rack 3 is fixed to the installment surface of the electricity storage apparatus B.

The rack 3 includes the support plates 31 and the brackets 32.

The support plate 31 is a plate-shaped member that supports either the battery module 1 or the control unit 2. As shown in FIG. 2, the rack 3 includes a plurality of the support plates 31, the support plate 31 positioned on the uppermost stage supports the control unit 2, and the other support plates 31 support the battery modules 1.

The support plates 31 are joined to the other support plates 31 via the brackets 32 fastened on the main surfaces.

Here, out of the support plates 31 included in the rack 3, the support plate 31 positioned to be closest to the z-axis negative side, in other words, the lowermost side in the vertical direction is fastened to the bottom surface of the casing 4. The support plate 31 may be directly fastened to the bottom surface of the casing 4 or may be fastened to the bottom surface of the casing 4 via a connecting tool and the like. As described above, the support plates 31 are joined to each other via the brackets 32, and hence all of the support plates 31 are fixed to the casing 4 by the configuration as described above.

FIG. 3 is a perspective view showing the configuration of the battery module and the support plate according to the first embodiment.

As shown in FIG. 3, regarding the battery module 1 according to the present embodiment, the bottom surface is in abutment against the main surface of the support plate 31 and is supported from the vertical-direction lower side. Here, as described above, the bottom surface of the battery module 1 according to the present embodiment and the main surface of the support plate 31 are fastened to each other.

A method of fastening the bottom surface of the battery module 1 and the main surface of the support plate 31 to each other is not particularly limited, but any method may be used as long as the method can suitably fix the battery module 1 and the support plate 31 to each other. For example, the battery module 1 and the support plate 31 according to the present embodiment may be mechanically fastened to each other at four corners of the bottom surface of the battery module 1.

With such configuration, the battery module 1 according to the present embodiment is suitably supported by the main surface of the support plate 31 against shaking in the z-axis direction, in other words, the height direction, and is suitably fixed to the support plate 31 by mechanical fastening against shaking in a direction parallel to the xy-plane, in other words, the horizontal plane.

Therefore, the electricity storage apparatus B according to the present embodiment is able to sufficiently fix the battery modules 1 that are accommodated. As a result, the electricity storage apparatus B according to the present embodiment enables the quake resistance to be improved.

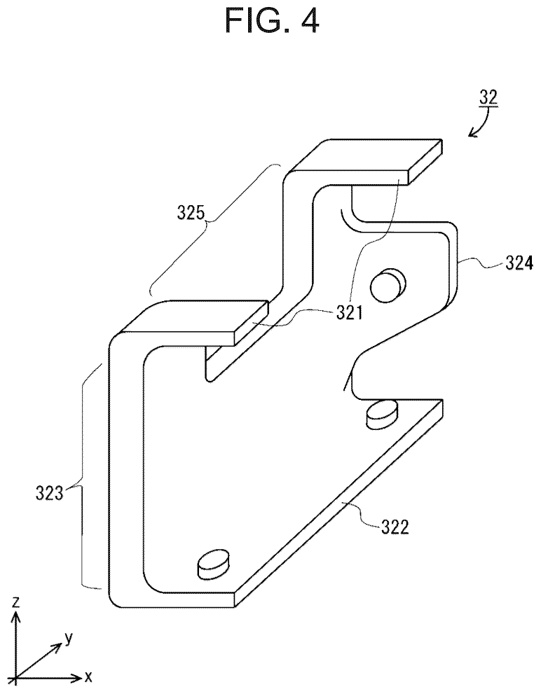

FIG. 4 is a perspective view showing the configuration of the bracket according to the first embodiment.

The bracket 32 is a structure body having a U-shaped section in at least a part thereof and joins the support plates 31 to each other.

The bracket 32 according to the present embodiment includes upper-side support plate fastening portions 321, a lower-side support plate fastening portion 322, a joining portion 323, a side wall fastening portion 324, and a hole portion 325.

The upper-side support plate fastening portions 321 are plate-shaped parts parallel to the xy-plane, and one is provided on each of the positive side and the negative side in the y-axis direction across a part corresponding to the hole portion 325 in the bracket 32 according to the present embodiment. The upper-side support plate fastening portions 321 are fastened to the main surface of the support plate 31 positioned on the z-axis positive side, in other words, the vertical-direction upper side.

A method of fastening the upper-side support plate fastening portions 321 and the support plate 31 to each other is not particularly limited and may be mechanically fastening or fastening by welding, for example.

The lower-side support plate fastening portion 322 is a plate-shaped part parallel to the xy-plane and extends in the y-axis direction. The lower-side support plate fastening portion 322 is fastened to the main surface of the support plate 31 positioned on the z-axis negative side, in other words, the vertical-direction lower side.

A method of fastening the lower-side support plate fastening portion 322 and the support plate 31 to each other is not particularly limited and may be mechanically fastening or fastening by welding, for example.

The joining portion 323 is a plate-shaped part parallel to the yz-plane and connects the upper-side support plate fastening portions 321 and the lower-side support plate fastening portion 322 to each other. The hole portion 325 is provided in a central part of the joining portion 323 on the vertical-direction upper side of the joining portion 323. The joining portion 323 faces one side surface of the battery module 1 in a substantially parallel manner and protects the side surface of the battery module 1.

Here, in the present embodiment, when a part obtained by combining the upper-side support plate fastening portions 321, the lower-side support plate fastening portion 322, and the joining portion 323 is cut off at a cutting surface parallel to the zx-plane, a U-shaped section is obtained.

With such configuration, the bracket 32 according to the present embodiment is able to firmly fix the support plates 31 to each other. As a result, the quake resistance of the rack 3 according to the present embodiment is improved.

As a matter of course, the sectional shape of the part obtained by combining the upper-side support plate fastening portions 321, the lower-side support plate fastening portion 322, and the joining portion 323 is not limited to a U-shape and may be an H-shape or an I-shape, for example.

In other words, the bracket 32 according to the present disclosure may have any sectional shape as long as the brackets 32 have a shape that can suitably fix and join the support plates 31 to each other.

The side wall fastening portion 324 is fastened to the side wall of the casing 4. In other words, the side wall fastening portion 324 is fastened to the inner wall surface parallel to the vertical direction out of the inner wall surfaces included in the casing 4. In more detail, the side wall fastening portion 324 according to the present embodiment is fastened to the wall surface parallel to the zx-plane, in other words, the inner wall surface corresponding to the main surface of the casing main body 41 out of the inner wall surfaces included in the casing 4.

With such configuration, the rack 3 is fixed to the casing 4 in a firmer manner, and hence it is possible to improve the quake resistance of the electricity storage apparatus B more.

The side wall fastening portion 324 according to the present embodiment is disposed so as to be perpendicular to the upper-side support plate fastening portions 321, the lower-side support plate fastening portion 322, and the joining portion 323.

With such configuration, the rack 3 is fixed to the casing 4 in a further firmer manner, and hence it is possible to further improve the quake resistance of the electricity storage apparatus B.

The hole portion 325 functions as a passage provided for causing a cable extending from the battery module 1 to pass therethrough. By the configuration as above, the electricity storage apparatus B according to the present embodiment enables a passage of the cable (not shown) extending from the battery module to be to secured.

As described above, the electricity storage apparatus B according to the present embodiment is an electricity storage apparatus including the battery modules 1 and the rack 3 that accommodates the battery modules. The rack 3 has the support plates 31 that support the battery modules, and the bottom surfaces of the battery modules 1 and the main surfaces of the support plates 31 are fastened to each other. By the configuration as above, the electricity storage apparatus B enables the quake resistance to be improved.

The electricity storage apparatus B according to the present embodiment includes a plurality of the battery modules 1 and the support plates 31, and the support plate 31 is joined to another support plate 31 via the brackets 32 having a U-shaped sectional shape. By the configuration as above, the electricity storage apparatus B enables the quake resistance to be improved more.

The electricity storage apparatus B according to the present embodiment further includes the casing 4 disposed such that the sealing surface does not intersect with the rack 3. By the configuration as above, the electricity storage apparatus B according to the present embodiment enables durability to be improved.

The casing 4 according to the present embodiment is fastened to the brackets included in the rack 3 at the side wall of the casing 4. By the configuration as above, the electricity storage apparatus B according to the present disclosure enables the quake resistance to be further improved.

The present disclosure has been described above in accordance with the embodiment described above, but the present disclosure is not limited to the configuration of the embodiment described above, and it goes without saying that various modifications, changes, and combinations that may be made by a person skilled in the art within the scope of the disclosure in the claims of the present application are included.

What is claimed is:

1. An electricity storage apparatus, comprising:
a plurality of battery modules; and
a rack that accommodates the battery modules, wherein:
the rack has a plurality of support plates that supports the battery modules;
a bottom surface of each of the battery modules and a main surface of each of the support plates are fastened to each other; and
each of the support plates is joined, via a bracket fastened on the main surface of the support plate, to another of the support plates.

2. The electricity storage apparatus according to claim 1, wherein the bracket has a U-shaped section.

3. The electricity storage apparatus according to claim 1, further comprising a casing that accommodates the battery modules and the rack, wherein the bracket is fastened to a side wall of the casing.

4. The electricity storage apparatus according to claim 1, further comprising a casing that accommodates the battery modules and the rack, wherein a sealing surface of the casing is disposed so as not to intersect with the rack.
